(19) United States
(12) Patent Application Publication
(10) Pub. No.: US 2010/0124506 A1
(43) Pub. Date: May 20, 2010

(54) VERTICAL AXIS WIND TURBINE BLADE

(75) Inventors: Leon E. Richartz, Carson City, NV (US); Rory R. Davis, Gardnerville, NV (US)

Correspondence Address: DLA PIPER LLP (US ), 2000 UNIVERSITY AVENUE, EAST PALO ALTO, CA, 94303-2248, US

(73) Assignee: Great Wind Enterprises, Inc., Alameda, CA (US)

(21) Appl. No.: 12/271,800

(22) Filed: Nov. 14, 2008

(51) Int. Cl. F03D 1/06

(52) U.S. Cl. 416/241 R; 416/1

(57) ABSTRACT

A blade for a wind turbine, such as vertical axis wind turbine, is disclosed.

### FIELD

The disclosure relates to a blade for a wind turbine and in particular a blade for a vertical axis wind turbine.

### BACKGROUND

A Darrieus-type vertical axis wind turbine (“VAWT”) typically has two curved blades joined at the ends to the top and bottom of a rotatable, vertical tower. The two or more blades bulge outward to a maximum diameter about midway between the blade root attachments points at the top and bottom of the tower. See U.S. Pat. No. 1,835,018 to D. J. M. Darrieus for a basic explanation of a VAWT. The rotatable, vertical tower with the blades attached will be referred to herein as a tower or tower assembly. A typical VAWT supports the bottom of the tower on a lower bearing assembly, which in turn is elevated off the ground by a base. The rotation of the tower is coupled to and drives an electrical generator, typically located in the base, which produces electrical power as the tower rotates. The top of the tower is supported by an upper bearing assembly that is held in place by guy wires or other structures. See U.S. Pat. No. 5,531,567 which shows examples of two typical VAWTs.

A key component of the VAWT is the blades, which interact with the wind to create lift forces that rotate the tower and drive the generator. The blades typically have a symmetrical or semi-symmetrical airfoil shape in cross-section with a straight chord that is oriented tangential to the local radius of the turbine. The tower rotates to give the blades greater velocity than the wind, and the angle of attack that the wind generates causes lift forces on the blades that maintain rotation of the tower. The lift forces are periodic because each blade goes through two phases of no lift per revolution when the blade is moving either straight up-wind or straight down-wind. In addition to the wind-generated lift forces, centrifugal forces also act on the blades.

A slender structure like a VAWT blade attached by its ends to a rotating axis tends to take the shape of a troposkein when the tower rotates. A troposkein is the shape that a linearly-distributed mass like a skipping rope would take under centrifugal force when the rope is spun around an axis. Considering just centrifugal forces, the spinning rope takes the troposkein shape and is loaded in pure tension because it has negligible stiffness or resistance to bending. It is desirable for a VAWT blade to have a troposkein shape in order to minimize bending stresses and fatigue loads, but a practical problem is how to design a VAWT blade so that it is flexible enough to assume a troposkein shape yet rigid enough to withstand operating loads, including the significant loads that result from gravity. Thus, it is desirable to provide a vertical axis wind turbine blade that overcomes the above problems and it is to this end that the disclosure is directed.

### BRIEF DESCRIPTION OF THE DRAWINGS

FIG. 1 illustrates a vertical axis wind turbine with one or more blades;

FIG. 2 illustrates a cross section of each blade of the VAWT; and

FIGS. 3A-3E are diagrams illustrating a VAWT blade in different states.

### DETAILED DESCRIPTION OF ONE OR MORE EMBODIMENTS

The disclosure is particularly applicable to a blade for a vertical axis wind turbine with the particular construction set forth below and it is in this context that the blade will be described. It will be appreciated, however, that the blade has greater utility since it may be constructed out of different materials and be used for different types of wind turbines. The disclosure is also particularly applicable to larger VAWTs rated greater than 500 kW, but the same features can be beneficial for smaller machines as well.

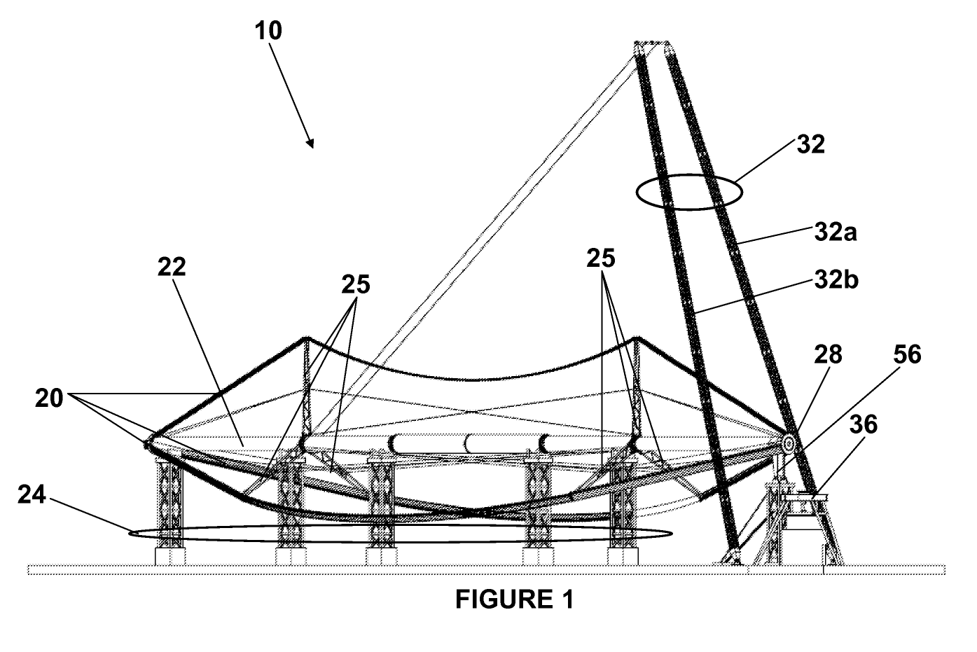

FIG. 1 shows a side view of a VAWT structure 10 with three blades 20 in an assembly position. The VAWT structure 10 may also have a mast 22 and one or more struts 25 connected to the mast that support the blades 20 of the VAWT structure. The VAWT structure that can be erected using the techniques described below may include vertical axis wind turbines that have a 20 to 200 meter diameter, 50 to 400 meter rotor height and weigh 20 to 3000 tons.

In one embodiment, a plurality of support frames 24 are designed to support the mast 22 of the VAWT structure 10 while it is in the assembly position which may be horizontal. The height of each support frame 24 may be different depending on the site elevation or the terrain of the ground. The mast 22 has a base part 28 wherein the mast 22 will fit accurately into a base support 36 that supports the weight of the VAWT structure 10 once it is installed. The base support may also house a generator that is coupled to the structure 10 and generates power as the blades catch the wind/air flow and turn the wind turbine. A support structure 56 may rotatably connect to the bottom portion of the VAWT structure 10 so that the VAWT structure 10 can be rotated (using a gin pole assembly 32) relative to the support structure 56 so that the bottom of the VAWT structure 10 when erected will interface with the base 36.

The VAWT structure 10 (and the mast 22 and blades 20) is erected using the gin pole assembly 32. In one implementation, the gin pole assembly 32 may include a first gin pole 32a and a second gin pole 32b that are joined together at an upper end of each gin pole by a connector. Each gin pole also has a bottom end that is pivotally anchored to the ground by a gin pole base that allows the gin pole to be pivoted about the base. In operation, the VAWT structure 10 spins about the base 36 and turns the generator that is located in the base. Each blade interacts with the wind to create lift forces that rotate the tower and drive the generator. Now, the blades are described in more detail.

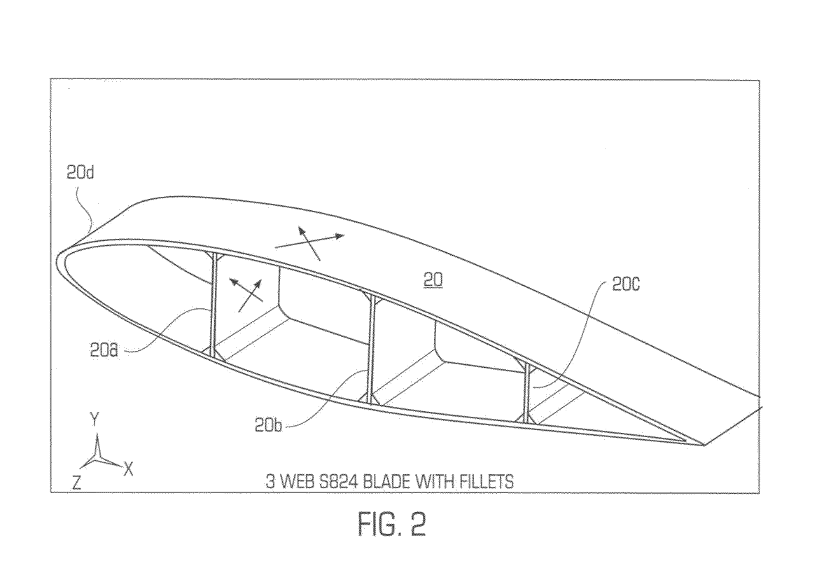

FIG. 2 illustrates a cross section of each blade 20 of the VAWT. As shown each blade 20 has an airfoil shape with one or more webs 20, such as webs 20a, 20b and 20c as shown in the example in FIG. 2, that support an outer surface 20d of the blade. In all prior VAWTs, the blades have been made very stiff so that they do not significantly deflect under all operating and non-operating conditions. In order to achieve this, the machines also are by necessity designed with low height to diameter ratios (about 1.5), and the blades must be made in the curved/bent shape. The blades described herein use less stiff blades that are lower cost and lighter, and can be made straight, then bent into shape, which also reduces the cost of manufacture.

One good choice of material for these blades is fiberglass/polymer fibrous composite, such as E-glass fiber/polyester resin. The thickness to chord ratio for the blades is commonly 20% or less, to avoid excessive drag for the given lift. The softer direction of bending for the blades, referred to as the “flatwise” direction, gives the blades their flexibility to follow the troposkein shape within a vertical plane. In addition, the relatively soft flatwise bending behavior allows the blades to flex inward towards the mast when high winds occur, when the machine is not operating, thus avoiding damage that would otherwise occur (the costly alternative is to make the blades much heavier and make the machine much shorter for the given diameter). The flexible nature of the lightweight blade is coordinated with the larger height to diameter ratio of the machine (2.5 to 3.5) to allow the flex or “rollthrough” of the blade without damage.

The ability to tolerate high winds by blade roll-through despite the light weight of the blade, reduces the machine cost substantially. The weight of the blade is reduced itself, and the weight of the other components that carry the blades can also be reduced (mast, struts, guy cables), because they have less blade weight to carry. A lighter machine has less rotordynamic problems so guy cables can be made smaller and less stiff. The direct cost of making the blade is reduced because it can be made straight, not curved, most efficiently by “pultrusion”, which is a low cost process of extrusion molding of composites. And finally, most importantly, the larger height to diameter ratio of the machine, allowed by and coordinated with such blade design, provides much more swept area per unit area of land, and that translates into more energy capture for a given land area. The result is a much more cost-efficient large VAWT machine.

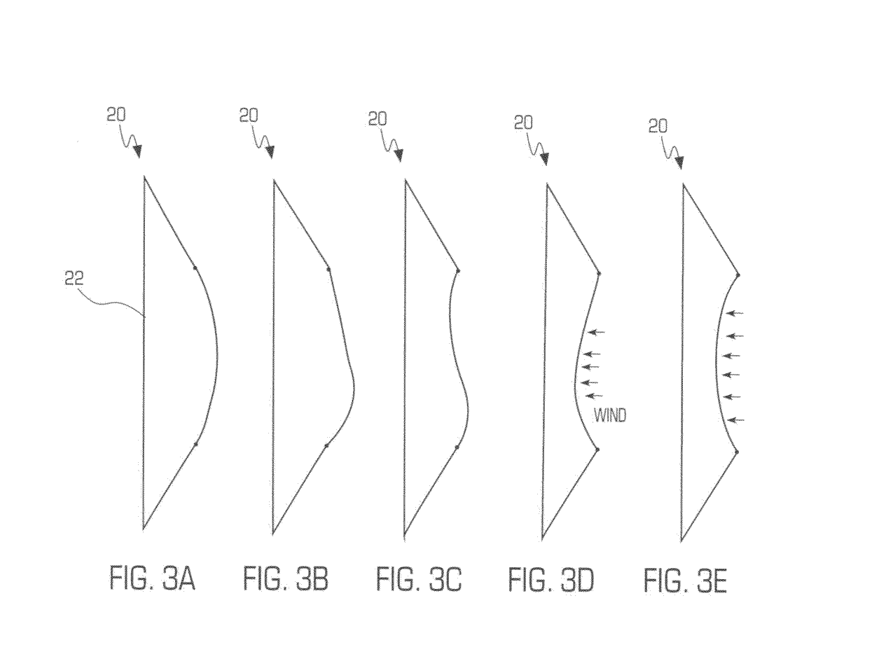

FIGS. 3A-3E are diagrams illustrating a VAWT blade in different states. FIG. 3A illustrates a blade 20 along the length of the mast 22 during operation of the vertical axis wind turbine shown in FIG. 1. During operation of the vertical axis wind turbine, the blade has a convex shape as shown during the centrifugal forces. FIG. 3B shows the blade when the operation of the vertical axis wind turbine is slowing down and/or stopped so that gravity causes the blade to sag towards the ground. For example, when the wind gets very strong (high wind speed), the VAWT structure 20 is stopped with one blade upwind. The transition from the operational convex shape to a high wind concave shape (as described below) is aided by the asymmetric gravity sag of the blade as shown in FIG. 3B (somewhat exaggerated for illustration purposes), and is allowed without damage by the flatwise bending flexibility of the blade coordinated with the blade segment's ratio of bend displacement to length. The less the blade is bent in comparison with it's length, the easier it will roll through from convex to concave, and the less the stresses will be when bent or when rolling through. On the other hand, if the convex shape has too little bending, the blade centrifugal forces can get too high during operation. So there is a “happy medium” bend to length ratio, and for example, the blade may use a ratio of between 0.120 to 0.130 and particularly about 0.125.

During a high wind speed condition, the upwind blade starts at the gravity sag state as shown in FIG. 3B and that upwind blade rolls through several states as shown in FIGS. 3C-3E and carries high wind load primarily in tension. As shown in FIG. 3C, a top portion of the blade thus rolls through first in somewhat of an S shape towards the concave shape. This rolling avoids the more severe snap-through that could occur with a higher number of wavelengths such as 1.5 (and higher bending stresses in the blade). The roll-through is fairly slow, on the order of 5-10 seconds in a large machine due to the long blade length and air resistance normal to the airfoil shape (like flat plate drag), i.e. there is natural damping to prevent “snapping” and dynamic amplification of stresses. As shown in FIG. 3D, the roll through is completed as the lower portion of the blade takes on the concave shape so that the wind force load is handled by tension of the blade as shown in FIG. 3E. When wind speed has lowered, the machine is automatically restarted, the VAWT structure 10 slowly starts to spin and the centrifugal force caused by the spinning causes the blades 20 to return to their operational convex shape as shown in FIG. 3A. The upper half of the blade will roll through first, again due to gravity sag shape, followed by the lower half. In one embodiment, the generator of the VAWT structure is run in motor mode to start the rotation of the blades. However, in another embodiment, the VAWT may be self-starting.

The blade stiffness and installed curvature is specifically designed to allow this roll-through behavior with acceptable bending stresses well below failure levels of the material used to manufacture each blade, such as a composite material in one embodiment. Each blade may also be made of metal material, provided the flatwise bending stiffness is kept relatively low in relation to the blade length. Any metal is usable, but lower modulus/weight metal such as aluminum is most appropriate, or metal composite designs. In addition, extrudable metals may be better for cost. For the composite blade embodiment, the composite material allows somewhat soft bending stiffness but still high torsional stiffness to resist aerodynamic flutter in operation. In one embodiment, this is achieved by using 1) a substantial percentage of bias (+/−45 degree) fibers in the blade construction, and 2) closed cross section geometry to maximize torsional rigidity, with structural continuity of +/−45 degree fibers all around the closed sections such as shown by the arrows in FIG. 2 above. For example, one blade uses about 40% bias and 60% spanwise axial fiber in its blade construction. This design approach precludes the higher fabrication and maintenance cost of articulated struts or other measures to allow the blade to hang straight when not operating (and thus not buckle in high winds).

As a means of illustration, one embodiment uses a blade segment length of 67.17 m across a blade span of 64.67 m. When the blade is bent into place, the bend displacement is 8.2 m, for an installed bend to span ratio of 0.127. The bending rigidity, or area moment of inertia in flatwise bending times the modulus, is 1.8E6 N-m², giving a rigidity to span ratio of 24000 N-m, which provides the flexibility to keep bending stresses below about 140 MPa during rollthrough. Such stress is acceptable for a typical 40% bias/60% spanwise E-glass/polyester blade laminate. This not a unique set of properties that will achieve the purposes of the disclosure, but is rather just an example.

While the foregoing has been with reference to a particular embodiment of the invention, it will be appreciated by those skilled in the art that changes in this embodiment may be made without departing from the principles and spirit of the invention, the scope of which is defined by the appended claims.

1. A blade for a wind turbine, comprising:
a outer surface over one or more webs that form an airfoil that has a convex shape when being rotated due to centrifugal force; and
wherein the blade rolls through from the convex shape to a concave shape when not being rotated to withstand wind forces in tension.

2. The blade of claim 1, wherein the blade is made of a fiberglass and polymer fibrous composite material.

3. The blade of claim 2, wherein the composite material has a percentage of bias fibers and a percentage of spanwise axial fibers.

4. The blade of claim 3, wherein the composite material has a 40% bias fibers and 60% spanwise axial fibers.

5. The blade of claim 1, wherein the blade is made of metal.

6. The blade of claim 5, wherein the metal is aluminum.

7. The blade of claim 1, wherein the blade has a bend to length ratio of between 0.120 to 0.130

8. The blade of claim 7, wherein the bend to length ratio is about 0.125.

9. A wind turbine with one or more blades, comprising:
a mast;
one or more blades attached to the mast;
a generator rotatably attached to the mast that generates energy as the mast rotates due to wind force on the one or more blades; and
wherein each blade further comprises a outer surface over one or more webs that form an airfoil that has a convex shape when being rotated due to centrifugal force and wherein the blade rolls through from the convex shape to a concave shape when not being rotated to withstand wind forces in tension.

10. The wind turbine of claim 9, wherein the blade is made of a fiberglass and polymer fibrous composite material.

11. The wind turbine of claim 10, wherein the composite material has a percentage of bias fibers and a percentage of spanwise axial fibers.

12. The wind turbine of claim 11, wherein the composite material has a 40% bias fibers and 60% spanwise axial fibers.

13. The wind turbine of claim 9, wherein the blade is made of metal.

14. The wind turbine of claim 13, wherein the metal is aluminum.

15. The wind turbine of claim 9, wherein the blade has a bend to length ratio of between 0.120 to 0.130

16. The wind turbine of claim 15, wherein the bend to length ratio is about 0.125.

17. The wind turbine of claim 9, wherein the wind turbine is a vertical axis wind turbine.

18. A method for operating a vertical axis wind turbine having a mast, one or more blades attached to the mast and a generator rotatably attached to the mast that generates energy as the mast rotates due to wind force on the one or more blades, the method comprising:
rotating the mast due to wind force on the one or more blades wherein the blades have a convex shape while rotating; and
rolling each blade into a concave shape when the mast is not rotating to survive a high wind force condition.

19. The method of claim 18, wherein rolling each blade into a concave shape occurs during a 5 to 10 second period of time.
